(19) United States
(12) Patent Application Publication
(10) Pub. No.: US 2016/0354267 A1
(43) Pub. Date: Dec. 8, 2016

(54) TRANSFER DEVICE

(71) Applicant: AUGMENT CO., LTD., Tsukuba-city (JP)

(72) Inventor: Sadao MASAKI, Chiba (JP)

(21) Appl. No.: 14/912,760

(22) PCT Filed: Dec. 3, 2015
(86) PCT No.: PCT/JP2015/084026

§ 371 Date: Feb. 18, 2016

(30) Foreign Application Priority Data
Dec. 15, 2014 (JP) 2014-252640

(51) Int. Cl. A61G 7/10

(52) U.S. Cl. CPC A61G 7/1017; A61G 7/1046; A61G 7/1001; A61G 7/1034; A61G 7/1044; A61G 7/1051; A61G 7/1092; A61G 7/109

(57) ABSTRACT

[Problem] To decrease the burden on a caregiver.

[Solution] A transfer device is provided with: a U-shaped frame including an upper side and a lower side opposed to each other; protrusion members; first arms connected to end portions of the protrusion members; second arms pivotally connected to end portions of the first arms; a first bar member connecting the end portions of the first arms; a second bar member connecting the second arms; a cylinder pivotally grasped by a grasping member fixed to the upper side; a connecting member connecting an end portion of the cylinder and the first bar member; an elongated-hole member fixed to the upper side and having an elongated hole; a third arm fixed to an engagement pin engaged in the elongated hole; an arm connecting member fixed to the second bar member and connected to the other end of the third arm; leg portions connected to the lower side; and a plurality of wheels fitted to the frame and the leg portions.

### TECHNICAL FIELD

The present invention relates to a transfer device for moving a person in need of nursing care between, e.g., bed, wheelchair, and lavatory or the like, particularly a transfer device that enables the transfer of a person in need of nursing care even by a single caregiver.

### BACKGROUND ART

As the number of elderly persons requiring nursing care increases, the problem of increasing burden on caregivers is gaining attention in recent years. The caregiver needs to move the person in need of nursing care from bed to wheelchair, or from wheelchair to the toilet seat in the lavatory, for example, involving extremely hard work. Many caregivers even leave the job on account of damaged lower back due to repeated movements to hold up the person in need of nursing care. If the retiring caregivers increase, the remaining caregivers are left with more burden. The remaining caregivers may also hurt their lower back and leave, creating a vicious cycle.

In order to decrease the burden on caregivers, transfer devices for assisting the movement of the person in need of nursing care have been developed. An example of the transfer device is disclosed in Patent Document 1. Patent Document 1 discloses transfer equipment provided with a carriage; a support column that can be tilted forward and backward from an upright position on the carriage; a chest region support unit disposed on top of the support column to support the chest region of the person receiving the nursing care; and a pair of shin region support units disposed on both sides of a lower portion of the support column to support the shin regions of the person receiving the nursing care. The transfer equipment is described as being capable of reducing the physical and emotional burden on medical personnel, the caregiver, the sick, or the person receiving the nursing care, without using electric power for motors and the like.

### CITATION LIST

### Patent Document

### PATENT DOCUMENT 1: JP-A-2014-14573

### SUMMARY OF INVENTION

### Problems to be Solved by the Invention

However, the typical transfer devices such as disclosed in Patent Document 1 cannot be inserted from bed side into the bed. Thus, the person in need of nursing care cannot be moved onto the transfer device in a lying orientation, and the caregiver needs to hold up the person and change his or her orientation. In addition, when placing a belt for supporting the person in need of nursing care from under the buttocks of the person, at least two caregivers have to hold the person to lift the person's buttocks to place the belt. Thus, at least two caregivers are required, and their lower backs are burdened by the work of holding up the person.

Thus, with the typical transfer device such as disclosed in Patent Document 1, at least two people are required to hold up the person in need of nursing care so as to place the person on the transfer device. Accordingly, both the burden in terms of the number of caregivers and the burden on the lower back of the caregivers are large. The present invention was made in view of such circumstances, and an object of the present invention is to provide a transfer device that can decrease both the burden in terms of the number of caregivers and the burden on the lower back of the caregivers.

### Solutions to the Problems

In order to solve the above described problem, a transfer device for transferring a person in need of nursing care according to the present invention includes: a U-shaped frame including an upper side and a lower side opposed to each other; a transfer unit mounted to the upper side to lift the person in need of nursing care; and a leg portion mounted to the lower side. Thus, because the transfer device is provided with the U-shaped frame, the transfer device can be inserted into the bed in such a manner as to sandwich the bed between the upper side and the lower side of the U-shaped frame. The person in need of nursing care can be moved onto the transfer device by simply raising the body of the person lying on bed. In addition, in the transfer device according to the present invention, the transfer unit includes: a pair of protrusion members fixed to the upper side; a pair of first arms pivotally connected to an end portion of the pair of protrusion members; a pair of second arms each pivotally connected to an end portion of each of the pair of first arms; a first bar member connecting the end portions of the pair of first arms; a second bar member connecting the pair of second arms; a cylinder pivotally grasped by a grasping member fixed to the upper side; a connecting member connecting an end portion of the cylinder and the first bar member so as to enable the cylinder to pivot; an elongated-hole member fixed to the upper side and having an elongated hole; a third arm having one end fixed to an engagement pin engaged in the elongated hole; and an arm connecting member fixed to the second bar member and connected to the other end of the third arm so as to enable the third arm to pivot. The leg portion is connected to the lower side in such a manner as to extend toward the second arm side with respect to a U-shaped plane of the frame, the leg portion having a wheel fitted thereto. Thus, the transfer device according to the present invention is provided with the U-shaped frame. Accordingly, the transfer device can be inserted into the bed in such a manner as to sandwich the bed between the upper side and the lower side of the U-shaped frame. The person in need of nursing care can be moved onto the transfer device by simply raising the body of the person lying on bed. Thus, the burden on the caregiver can be greatly decreased.

In the transfer device according to the present invention, the transfer device is configured to be switchable, by changing the position of the engagement pin in the elongated hole, between a mode in which the second arm is moved up and down while maintaining a horizontal state, and a mode in which the second arm is moved up and down while being inclined so as to be lower toward the frame when the cylinder is extended or contracted. The second arms are placed in the armpits of the person in need of nursing care, and the second arms are lifted while being inclined so as to be lower toward the frame. In this way, the lower back of the person in need of nursing care is lifted. Accordingly, a single caregiver can insert the belt under the buttocks of the person without having to lift the person. Accordingly, the burden on the lower back of the caregiver can be decreased.

Furthermore, in the transfer device according to the present invention, in a lateral projection view, by extending or contracting the cylinder, the second arm is lifted or lowered while maintaining a horizontal state when the cylinder is extended or contracted when the engagement pin is disposed in the elongated hole at a position where A=B, where A is a distance between a position in the elongated hole and a connection portion of the arm connecting member and the third arm, and B is a distance between a connection portion of the protrusion member and the first arm and the connection portion of the arm connecting member and the third arm. In this way, the second arms can be moved up and down while maintaining the horizontal state. Accordingly, the person in need of nursing care can be safely and stably moved onto or lowered from the transfer device.

Furthermore, in the transfer device according to the present invention, the transfer unit includes: a protrusion member fixed to the upper side; a first arm having one end pivotally connected to an end portion of the protrusion member via a first pin; a support member connected to another end portion of the first arm so as to enable the first arm to pivot; a pair of second arms connected to the support member; a cylinder and an engagement pin cylinder each having one end pivotally connected to a grasping member fixed to the upper side; a conversion member connecting the other end portion of the cylinder and the first pin to convert an extending/contracting motion of the cylinder into a pivoting motion of the first pin; an elongated-hole member fixed to the upper side and having an elongated hole; an engagement pin engaged in the elongated hole and fixed to the other end of the engagement pin cylinder so as to be movable in the elongated hole by an extending/contracting motion of the engagement pin cylinder; a third arm having one end fixed to the engagement pin; and an arm connecting member fixed to the support member and connected to the other end of the third arm so as to enable the third arm to pivot. The leg portion is connected to the lower side so as to extend in the same direction as the second arm with respect to a U-shaped plane of the frame, the leg portion having a wheel fitted thereto. Thus, the transfer device according to the present invention is provided with the U-shaped frame. Accordingly, the transfer device can be inserted into bed in such a manner as to sandwich the bed between the upper side and the lower side of the U-shaped frame, whereby the person in need of nursing care can be moved onto the transfer device by simply raising the body of the person lying on bed. In this way, the burden on the caregiver can be greatly decreased. Because the transfer device is provided with the engagement pin cylinder, the position of the engagement pin can be moved non-manually.

In the transfer device according to the present invention, the transfer device is configured to be switchable, by changing the position of the engagement pin in the elongated hole, between a mode in which the second arm is moved up and down while maintaining a horizontal state, and a mode in which the second arm is moved up and down while being inclined so as to be lower toward the frame when the cylinder is extended or contracted. Thus, with the second arms inserted in the armpits of the person in need of nursing care, the second arms can be lifted while being inclined so as to be lower toward the frame. In this way, the lower back of the person in need of nursing care is lifted, enabling a single caregiver to insert the belt under the buttocks of the person without having to lift the person. Accordingly, the burden on the lower back of the caregiver is also decreased. Further, because the transfer device is provided with the engagement pin cylinder, mode conversion can be performed non-manually.

In the transfer device according to the present invention, in a lateral projection view, by extending or contracting the cylinder, the second arm is lifted or lowered while maintaining a horizontal state when the cylinder is extended or contracted when the engagement pin is disposed in the elongated hole at a position where A=B, where A is a distance between a position in the elongated hole and a connection portion of the arm connecting member and the third arm, and B is a distance between a connection portion of the protrusion member and the first arm and the connection portion of the arm connecting member and the third arm. In this way, the second arm can be moved up and down while maintaining the horizontal state. Accordingly, the person in need of nursing care can be safely and stably moved onto or lowered from the transfer device.

Furthermore, in the transfer device according to the present invention, the upper side and the lower side of the frame are connected by an extendable/contractible member so as to make an interval between the upper side and the lower side adjustable. In this way, the height of the transfer device can be adjusted in accordance with the height of the transfer origin or transfer destination, such as a bed, a wheelchair, or the toilet bowl. Accordingly, the person in need of nursing care can be transferred easily.

In the transfer device according to the present invention, the pair of second arms is curved so as to embrace a space enclosed by the pair of second arms. The pair of second arms is configured to horizontally pivot. In this way, the second arms can be expanded by pivoting. Accordingly, the person in need of nursing care can be easily placed between the second arms. In this state, the second arms can be caused to pivot and become narrower, whereby the second arms can be easily set in the armpits of the person in need of nursing care. Further, the second arms are curved inwardly. Accordingly, the back of the person in need of nursing care can also be supported by the second arms. Even if the person leans backward, the person can be supported by the second arms and prevented from falling backward.

The transfer device according to the present invention further includes two leg portions. The two leg portions are configured to be adjustable in their mutual interval. In this way, the interval of the two leg portions can be adjusted in accordance with the size of the facility at the transfer origin or transfer destination, such as the width of the wheels of a wheelchair or the width of the toilet bowl. For example, in the case of a wheelchair, the interval of the leg portions can be adjusted so as to allow the two leg portions to enter between the wheels. In the case of the toilet bowl, the interval of the leg portions can be adjusted so as to allow the toilet bowl to be sandwiched between the two leg portions. Accordingly, various transfer origins and transfer destinations can be handled.

Furthermore, the transfer device according to the present invention includes two leg portions. The two leg portions are configured to horizontally pivot at their connection portions. In this way, by pivoting the two leg portions and adjusting their interval, the interval of the two leg portions can be adjusted in accordance with the size of the facility at the transfer origin or transfer destination, such as the width of the wheels of a wheelchair and the width of the toilet bowl. For example, in the case of a wheelchair, the interval of the leg portions can be adjusted so as to allow the two leg portions to enter between the wheels. In the case of the toilet bowl, the interval of the leg portions can be adjusted so that the toilet bowl can be sandwiched between the two leg portions. Accordingly, various transfer origins and transfer destinations can be handled.

In addition, the transfer device according to the present invention includes two leg portions. The leg portions have a part thereof horizontally pivotally formed. In this way, the interval of the two leg portions can be adjusted in accordance with the size of the facility at the transfer origin or transfer destination, such as the width of the wheels of a wheelchair or the width of the toilet bowl. For example, in the case of a wheelchair, the interval of the leg portions can be adjusted so as to allow the two leg portions to enter between the wheels. In the case of the toilet bowl, the interval of the leg portions can be adjusted so that the toilet bowl can be sandwiched between the two leg portions. Accordingly, various transfer origins and transfer destinations can be handled.

### Effects of the Invention

With the transfer device according to the present invention, both the burden in terms of the number of caregivers and the burden on the lower back of the caregivers can be decreased.

### BRIEF DESCRIPTION OF THE DRAWINGS

FIG. 1 is a perspective view showing a transfer device as a whole according to a first embodiment of the present invention.

FIG. 2 shows side views illustrating operation of the transfer device according to the first embodiment of the present invention.

FIG. 3 is a perspective view illustrating a state in which the lower back of the person in need of nursing care is being raised by the operation of the transfer device.

FIG. 4 is a perspective view illustrating a state in which the person in need of nursing care is being lifted by the transfer device.

FIG. 5 is a projection view toward the side of the transfer device illustrating the angle of second arms.

FIG. 6 is a perspective view illustrating a state of the person in need of nursing care on the bed being transferred.

FIG. 7 shows schematic front views of the transfer device with a frame with an extendable/contractible function.

FIG. 8 is a perspective view of the transfer device including leg portions that can horizontally pivot at connection portions thereof.

FIG. 9 is a perspective view of the transfer device including leg portions that look like mandibles of a stag beetle.

FIG. 10 is a perspective view illustrating the transfer device as a whole according to a second embodiment of the present invention.

FIG. 11 is a perspective view illustrating the transfer device as a whole according to the second embodiment of the present invention viewed from a different direction from FIG. 10.

FIG. 12 is an enlarged perspective view of the vicinity of an engagement pin of the transfer device according to the second embodiment of the present invention.

FIG. 13 is a perspective view toward the side of the transfer device illustrating the angle of second arms.

### DESCRIPTION OF EMBODIMENTS

In the following, preferable embodiments of a transfer device according to the present invention will be described with reference to the attached drawings.

### First Embodiment

### (1) Configuration

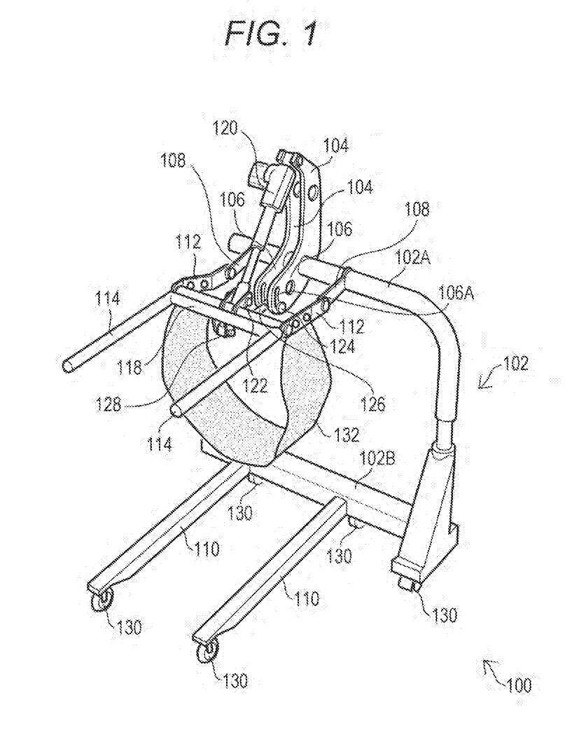

FIG. 1 is a perspective view illustrating a transfer device 100 as a whole according to the first embodiment of the present invention. As illustrated in FIG. 1, the transfer device 100 according to the first embodiment includes a U-shaped frame 102 including an upper side 102A and a lower side 102B. The upper side 102A is fitted with a transfer unit for lifting a person in need of nursing care. The transfer unit includes all that are mounted on the upper side 102A, as will be described below. On the upper side 102A, there are mounted a grasping member 104; elongated-hole members 106; and a pair of protrusion members 108, 108. The lower side 102B is provided with a pair of leg portions 110, 110.

To the end portions of the pair of protrusion members 108, 108, a pair of first arms 112, 112 is connected so as to pivot in a top-bottom direction. To the end portion of each of the pair of first arms 112, 112 (the end portions on the side not connected to the protrusion members 108), one of a pair of second arms 114, 114 is connected so as to pivot in the top-bottom direction. Thus, the second arms 114, 114 are configured with their longitudinal direction being perpendicular to a U-shaped plane of the U-shaped frame 102.

The end portions of the second arms 114, 114 (the end portions on the side not connected to the first arms 112) may preferably be adapted to pivot inward horizontally (not illustrated) and be fixed. In this way, when the person in need of nursing care is held between the second arms 114, 114, the end portions of the second arms 114, 114 can pivot inward and then be fixed, whereby the person in need of nursing care can have his or her back resting on that portion. Accordingly, the transfer can be performed safely with the person in need of nursing care feeling relaxed.

The end portions of the pair of first arms 112, 112 on the side of the second arms 114 are connected via a first bar member 116. The end portions of the pair of second arms 114, 114 on the side of the first arms 112 are connected via a second bar member 118. In FIG. 1, the first bar member 116 and the second bar member 118 are illustrated as being separate. However, the first bar member 116 and the second bar member 118 may be integral. The bar members are not limited to the bar shape and may have other shapes, such as a plate shape. Namely, the first bar member 116 and the second bar member 118 may include any and all members regardless of their shapes as long as they can connect the end portions of the first arms 112, 112 or the end portions of the second arms 114, 114.

The grasping member 104 has a cylinder 120 pivotally grasped at the top thereof. In FIG. 1, the grasping member 104 is configured of two plate members. However, the grasping member 104 may be configured of a single member. As the cylinder 120, arbitrary cylinders may be used, such as a hydraulic pressure cylinder, an air pressure cylinder, or an electric cylinder. An electric cylinder driven by an electric motor and gears may be preferable as it does not require hydraulic pressure or air pressure piping. While the grasping member 104 is designated as such, it is not necessarily required to grasp the cylinder 120. The cylinder 120 may be held by the grasping member 104 by any holding method as long as the cylinder can be pivotally held. Accordingly, the designation used, i.e., “grasping member”, refers to a member for holding the cylinder 120, and the method for holding is not limited to grasping.

The end portion of the cylinder 120 (the end portion on the side not grasped by the grasping member 104) is pivotally connected to a connecting member 122 mounted to the first bar member 116. The elongated-hole members 106 have elongated holes 106A formed therein. To an engagement pin 124 engaged in the elongated holes 106A to pivot in the elongated holes 106A, one end of the third arm 126 is fixed. The other end of the third arm 126 is pivotally connected to an arm connecting member 128 fixed to the second bar member 118.

The lower side 102B and the leg portions 110, 110 are fitted with a plurality of wheels 130. While the number of the leg portions 110 may be one, two may be preferable because one leg may be unstable and three or more legs may be meaningless. To each of the pair of first arms 112, 112, one or the other end of the belt 132 is connected. The belt 132 may preferably be connected to the connection portion between the first arms 112 and the second arms 114 on the first arms 112.

### (2) Operation with Wheelchair

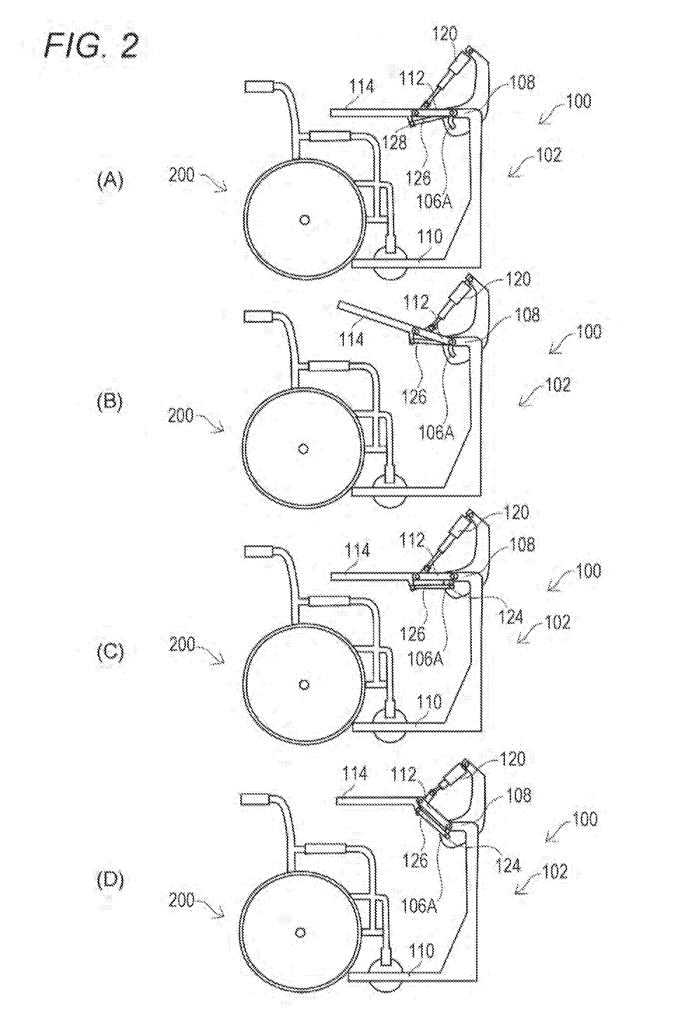

Operation of the first embodiment of the present invention will be described with reference to the drawings. FIG. 2 shows side views illustrating the operation of the transfer device according to the first embodiment of the present invention. In order to describe the operation to transfer the person in need of nursing care sitting in a wheelchair 200 in an easily understandable manner, illustration of the person in need of nursing care is omitted.

As in the state illustrated in FIG. 2(A), the transfer device 100 is brought close to the wheelchair 200. The person in need of nursing care (not illustrated) is asked to hold the second arms 114 in his or her armpits. Then, as illustrated in FIG. 2(B), the engagement pin 124 (which is hidden behind the first arms 112 and not visible) is positioned at the top in the elongated holes 106A, and the cylinder 120 is contracted. In this way, the second arms 114 are inclined and raised (so that the side of the person in need of nursing care becomes higher) while maintaining their state of being linearly aligned with the first arms 112. In other words, the second arms 114 and the first arms 112 are rotated about the connection portion between the first arms 112 and the protrusion members 108 while the linearly aligned state is maintained.

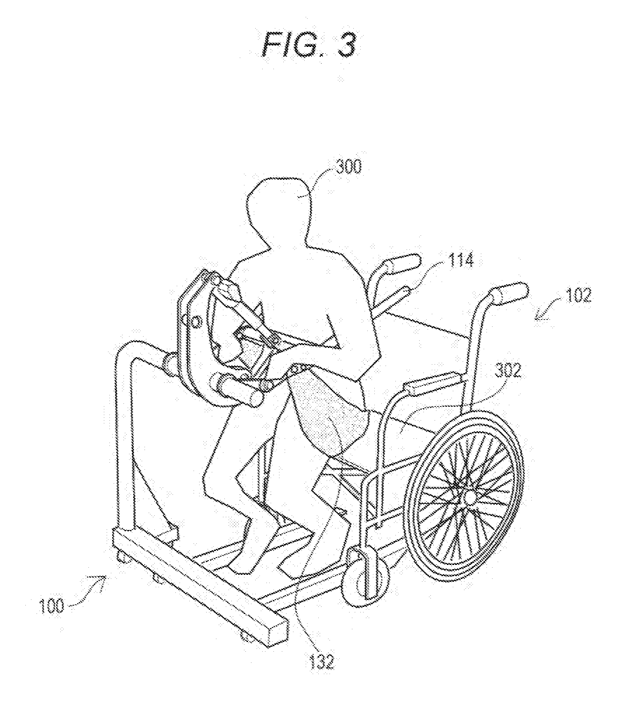

In this way, as illustrated in FIG. 3 (a perspective view illustrating the lower back of the person in need of nursing care being lifted by the operation of the transfer device), the person 300 in need of nursing care is raised diagonally by the second arms 114 under the armpits (so that the front of the person's body is lower and the back is higher). Accordingly, the buttocks are raised from a seat face 302 of the wheelchair 200.

In this way, even a single caregiver (not illustrated) can easily install the belt 132 under the buttocks of the person 300 in need of nursing care. With a typical transfer device, in order to install the belt under the buttocks of the person in need of nursing care, it has been necessary to lift the person with two caregivers. In contrast, with the transfer device 100 according to the present invention, a single caregiver can install the belt 132 under the buttocks of the person 300.

After the belt 132 is installed under the buttocks of the person 300, as illustrated in FIG. 2(C), the cylinder 120 is extended to lower the second arms 114 so as to sit the person in need of nursing care in the wheelchair 200. Thereafter, the engagement pin 124 is moved manually to the lower part of the elongated holes 106A. Then, as illustrated in FIG. 3(D), the cylinder 120 is contracted, whereby the second arms 114 rise while maintaining their horizontal state and without inclining.

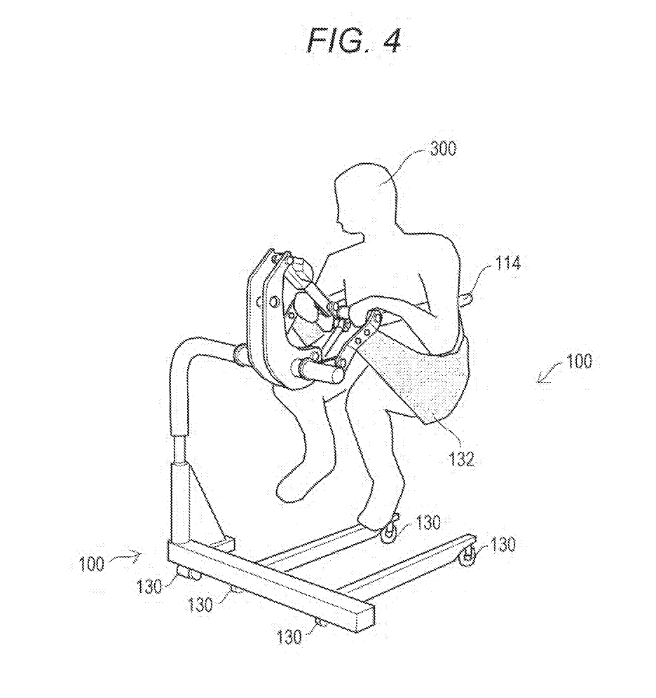

In this way, as illustrated in FIG. 4 (a perspective view illustrating a state in which the person in need of nursing care is being lifted by the transfer device), the buttocks of the person 300 are lifted by the belt 132 and also supported. Simultaneously, the person 300 is also supported on the armpits by the second arms 114. Accordingly, the person 300 can be stably lifted without causing the person to feel unsafe.

In the state of FIG. 4, the transfer device 100 is moved to the transfer destination, such as the lavatory or bed. The transfer device 100 is provided with wheels 130. Accordingly, the transfer device can be easily moved with the person 300 lifted. At the transfer destination, i.e., the bed, lavatory, or the like, the person 300 is lowered by the opposite procedure from the one described above. In this way, the person 300 in need of nursing care can be transferred to the transfer destination such as the bed or lavatory or the like.

Thus, by changing the position of the engagement pin 124 engaged in the elongated holes 106A of the elongated-hole members 106, the mode of the transfer device 100 according to the present invention can be converted on account of the function of the third arm 126 on the engagement pin 124 as the fulcrum when the cylinder 120 is contracted. Namely, the transfer device can be switched between a mode in which the second arms 114 are lifted while maintaining horizontal state, and a mode in which the second arms 114 are lifted while their linearly aligned state with the first arms 112 is maintained.

### (3) Second Arm Angle During Operation

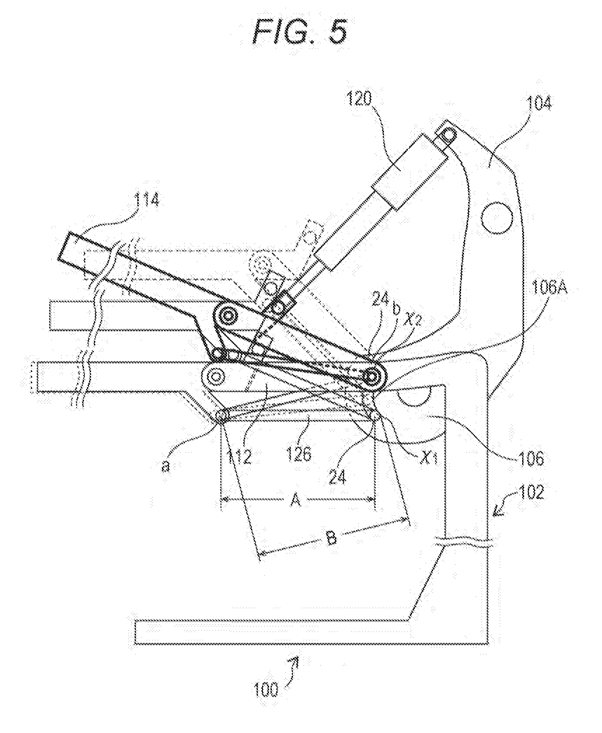

The angle of the second arms 114 in the case where the cylinder 120 is extended or contracted will be described with reference to FIGS. 1 and 5. FIG. 5 is a projection view toward the side of the transfer device, illustrating the angle of the second arms 114. FIG. 5 illustrates the second arms 114 at different angles. For ease of view of the drawing, reference signs for some parts are omitted. Referring to FIGS. 1 and 5, when the engagement pin 124 is at the same position in the projection view toward the side as the connection portion between the first arms 112 and the protrusion members 108, as the cylinder 120 is contracted, the third arm 126 is rotated about the position x₂ providing the fulcrum. Namely, in the side view, the third arm 126 is rotated about the same position as the connection portion between the first arms 112 and the protrusion members 108 as the fulcrum in the same way as the first arms 112. Accordingly, the second arms 114 supported on the third arm 126 are rotated while their linearly aligned state with the first arms 112 is maintained.

The present inventor has realized, after much research, that the second arms 114 can be raised while maintaining the horizontal state as the cylinder 120 is contracted when, in the projection view toward the side, the engagement pin 124 is positioned at position x₁ where A=B, where A is the distance between position x₁ of the engagement pin 124 in the elongated holes 106A and connected position a of the third arm 126 and the arm connecting member 128 (x₁−a distance), and B is the distance between connected position b of the first arms 112 and the protrusion members 108 and a (b−a distance).

In the transfer device 100 according to the present invention, the position x₁ where A=B is present in the elongated holes 106A. At this position, the engagement pin 124 can be positioned. Accordingly, the second arms 114 can be lifted and lowered while maintaining the horizontal state thereof. In this way, the body of the person in need of nursing care can be lifted and lowered continuously horizontally with the second arms 114 held in the armpits, without tilting the body of the person. Accordingly, the person can be stably transferred without causing a sense of fear in the person.

### (4) Operation on Bed

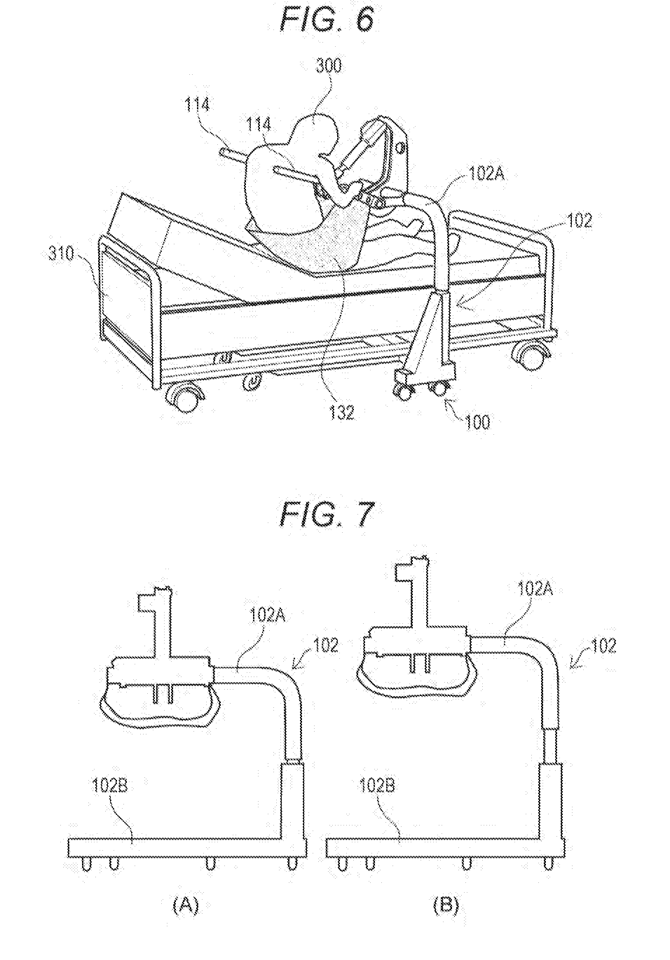

The transfer of the person in need of nursing care on bed will be described with reference to FIGS. 6 and 1. FIG. 6 is a perspective view illustrating a state of the person in need of nursing care on the bed being transferred. The transfer device 100 according to the present invention is equipped with the U-shaped frame 102. Accordingly, the transfer device 100 can be inserted into the bed 310 from the side of the bed 310 in such a manner as to sandwich the bed 310 between the upper side 102A and the lower side 102B.

In this way, as illustrated in FIG. 6, the second arms 114 can be located in front of the eyes of the person 300 in lying state. Accordingly, the caregiver does not need to change the orientation of the person 300. The caregiver can simply raise the person and place the second arms 114 in the person's armpits. In contrast, typical transfer devices are not provided with the U-shaped frame 102. Consequently, such transfer devices cannot be inserted from the side of the bed 310, requiring the caregiver to raise the person in need of nursing care, change his or her orientation, and then sit the person on the bed side, for example.

First, the transfer device 100 is inserted into the bed 310 from the side thereof. Then, the person 300 in need of nursing care is raised, and the second arms 114 are inserted in the person's armpits. The position of the engagement pin 124 is then adjusted, and the second arms 114 are lifted in the mode in which the second arms 114 are lifted (or lowered) while being inclined. In this way, the person 300 in need of nursing care leans forward, and hence the buttocks of the person 300 are slightly lifted. The caregiver (not illustrated) quickly places the belt 132 under the buttocks of the person 300, and then lowers the second arms 114.

Thereafter, the position of the engagement pin 124 is adjusted to the mode in which the second arms 114 are horizontally lifted (or lowered). As the second arms 114 are lifted, the person 300 in need of nursing care is supported under the buttocks by the belt 132. The armpits are supported by the second arms 114. Accordingly, the person can be safely and stably raised.

The transfer device 100 with the person 300 being lifted as described above is moved in front of a wheelchair, for example, and transferred thereon. When the person 300 in need of nursing care is transferred (lowered), the transfer can be performed by the opposite procedure from the one described above. Namely, the second arms 114 are lowered at the transfer destination in the mode for horizontal lifting and lowering so as to lower the person 300 once at the transfer destination.

Then, the position of the engagement pin 124 is adjusted to lift the second arms 114 in the mode in which the second arms 114 are lifted (lowered) in the inclined state with the frame-side end thereof positioned lower (the state in which the first arms 112 and the second arms 114 are linearly aligned). The person 300 in need of nursing care is leaned forward so as to raise his or her buttocks slightly, and the belt 132 is quickly removed from under the buttocks. Finally, the second arms 114 are lowered to transfer the person 300 onto the transfer destination completely. The second arms 114 are removed from the armpits, whereby the transfer is completed. In this way, the person can be transferred.

### (5) Variations of Parts of Transfer Device

Variations of the various parts of transfer device 100 according to the present invention will be described with reference to the drawings. FIG. 7 is a schematic front view of the transfer device of which the frame 102 has extendable/contractible function. As illustrated in FIG. 7, the vertical portion of the frame 102 connecting the upper side 102A and the lower side 102B preferably has the extendable/contractible function.

For the extendable/contractible function, various known methods may be employed. For example, a structure may be adopted in which an inner cylinder is inserted in an outer cylinder and fixed at arbitrary positions using stoppers such as screws. The present invention is not limited to the type such that an inner cylinder is inserted in an outer cylinder. In the case of this type, either the upper side 102A or the lower side 102B may be the outer cylinder or the inner cylinder.

In this way, the interval between the upper side 102A and the lower side 102B can be adjusted in accordance with the height of the transfer origin or transfer destination, such as the height of a bed, a wheelchair, or the toilet seat in a lavatory. Accordingly, the person 300 in need of nursing care can be transferred easily.

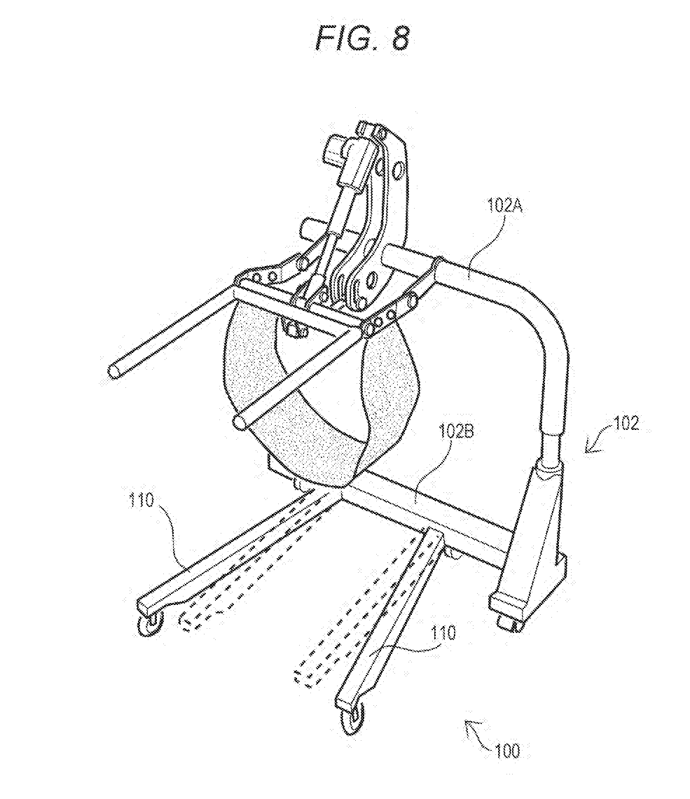

Reference is now made to FIG. 8. FIG. 8 is a perspective view of the transfer device of which the leg portions 110 are adapted to horizontally pivot at the connection portions thereof. As illustrated in FIG. 8, the two leg portions 110, 110 may be adapted to pivot at their roots (the portions connected with the lower side 102B) horizontally. Further, the leg portions 110 may be configured to be fixed at an arbitrary pivot angle.

In this way, even when the size of the toilet seat in the lavatory is too large to be placed between the two leg portions 110, 110, the end portions of the two leg portions 110, 110 can be expanded so as to allow the toilet seat in the lavatory to be placed between the two leg portions 110, 110, whereby the transfer device 100 can be inserted into the lavatory.

The leg portions 110, 110 may not be able to be placed between the wheels of a wheelchair due to the type of the wheelchair. In this case, the interval between the ends of the two leg portions 110, 110 may be narrowed so as to enable the two leg portions 110, 110 to be inserted between the wheels of the wheelchair, whereby the transfer device 100 can be set to the wheelchair.

Thus, the transfer device 100 can be adapted to expand or narrow the interval between the two leg portions 110, 110 so as to handle various transfer origins or transfer destinations. The method for expanding or narrowing the interval between the two leg portions 110, 110 may adopt, in addition to the method described above, a structure such that the interval is expanded or narrowed by sliding the two leg portions 110, 110 while they maintain a balanced state. In this case, a structure may be adopted in which the connection portion between one or both of the two leg portions 110, 110 and the lower side 102B can be moved along the lower side 102B.

The structure may include, for example, a structure in which the leg portions 110 can be detached and securely attached to the lower side 102B at another position; and a structure in which the connection portion between the leg portions 110 and the lower side 102B can be slid along the lower side 102B. However, the present invention is not limited to such structures and may adopt any structures capable of adjusting the interval between the leg portions 110, 110.

Whether the two leg portions 110, 110 are fixed or adapted for variable interval (including variable angles), the initial interval between the two leg portions 110, 110 may preferably be 260 mm to 300 mm and most preferably 280 mm. Researches by the present inventor have shown that with such intervals, various transfer origins and transfer destinations can be handled, such as wheelchairs and the toilet bowl of lavatories.

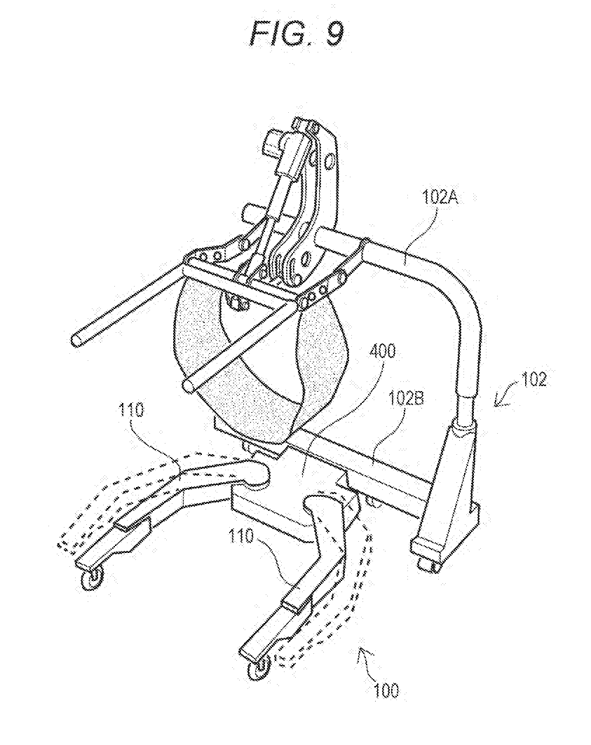

Another variation of the leg portions 110, 110 will be described with reference to the drawings. FIG. 9 is a perspective view of the transfer device including the leg portions having the shape of mandibles of a stag beetle. As illustrated in FIG. 9, the leg portions 110, 110 may have the shape of the mandibles of the stag beetle. Namely, the leg portions 110, 110 are horizontally pivotally mounted to a base 400 attached to the lower side 102B. The leg portions 110, 110 are configured to horizontally pivot from their midway points. The base 400 is not necessarily required, and the leg portions 110, 110 may be directly pivotally connected to the lower side 102B.

This configuration also makes it possible to handle various transfer origins and transfer destinations, such as wheelchairs and the toilet bowl in lavatories.

### Second Embodiment

### (1) Configuration

A second embodiment of the transfer device according to the present invention will be described with reference to the drawings. The second embodiment will be described by focusing on differences from the first embodiment, while omitting common portions. The operation and effects are similar to those of the first embodiment, and therefore description of similar operations and effects will be omitted.

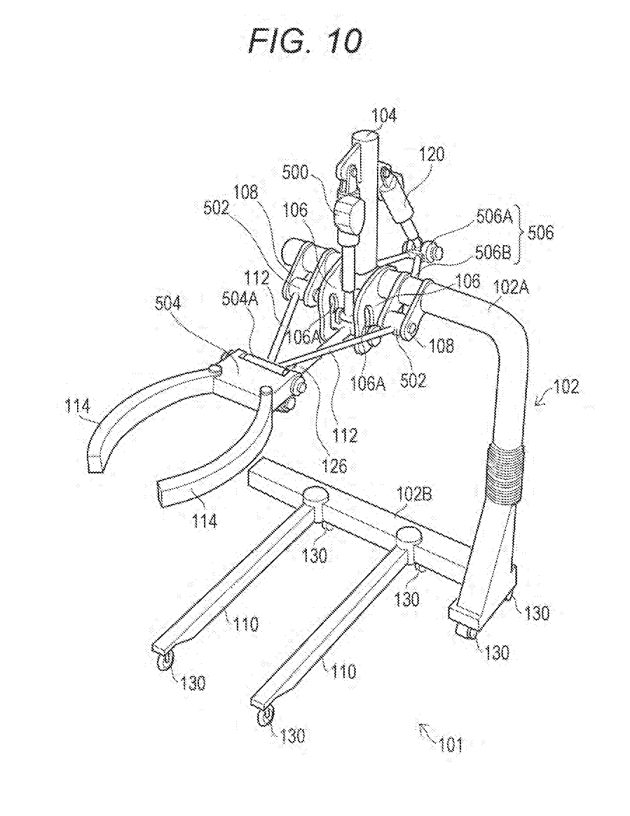

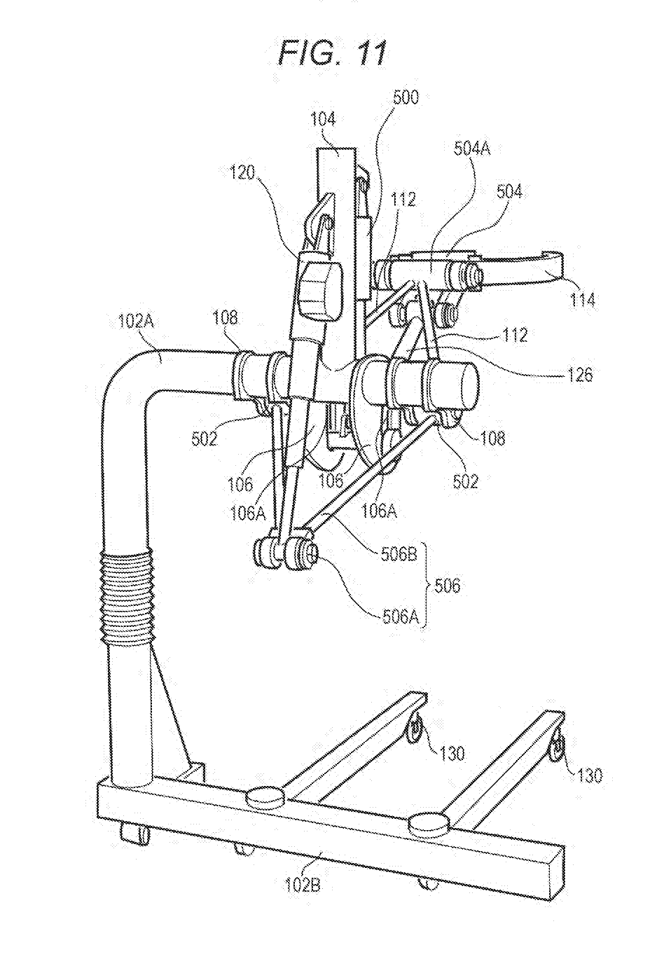

FIG. 10 is a perspective view illustrating the transfer device as a whole according to the second embodiment of the present invention. FIG. 11 is a perspective view of the transfer device according to the second embodiment as viewed from a different direction from FIG. 10. As illustrated in FIGS. 10 and 11, the transfer device 101 according to the second embodiment uses an engagement pin cylinder 500 so as to enable non-manual modification of the position of the engagement pin 124 in the elongated holes 106A in the transfer device 100 of the first embodiment.

Because the cylinder 120 cannot be mounted at the position according to the first embodiment, the cylinder 120 is installed on the other side of the plane including the U-shaped frame 102 (which is referred to as a frame plane) (i.e., on the opposite side, with respect to the frame plane, from the side on which the cylinder used to be located).

To protrusion members 108 fixed to the upper side 102A, first pins 502 are pivotally mounted. One end portions of the first arms 112 are connected to the first pins 502. The other end portions are connected to a pivotal pin 504A as part of the support member 504. The support member 504 is provided with the second arms 114, 114 that are inwardly curved. The second arms 114, 114 are configured to horizontally pivot about their connection portions with the support member 504 as the fulcrum.

The curved and pivotal second arms 114, 114 may be fitted to the transfer device 100 according to the first embodiment. In that case, the first embodiment may also be provided with the support member 504 as in the second embodiment. The second arms 114, 114 of the first embodiment may be similarly curved. In addition, the second arms 114, 114 of the first embodiment may be adapted to horizontally pivot at their intermediate points, or at their connection portions with the first arms 112 or in the vicinity thereof.

Because the second arms 114, 114 are each inwardly curved, when the second arms 114, 114 are placed in the armpits of the person in need of nursing care, the back of the person (not illustrated) can also be supported by the second arms 114, 114. Accordingly, the person in need of nursing care can be safely and stably transferred without the person falling back.

The second arms 114, 114 are pivotally configured. Accordingly, the person in need of nursing care can be placed between the second arms 114, 114 by expanding the second arms 114, 114. Thereafter, the second arms 114, 114 are closed. In this way, the second arms 114, 114 can be easily installed in the armpits of the person in need of nursing care.

Further, the second arms 114, 114 are horizontally pivotal. In this way, the interval of the second arms 114, 114 can be adjusted in accordance with the size of the body of the person in need of nursing care. Accordingly, persons in need of nursing care with a wide range of body sizes can be safely and stably transferred. The pivotal second arms 114, 114 may preferably be configured to be fixed at an arbitrary pivot position. By enabling the arms to be fixed at an arbitrary pivot position, the person in need of nursing care can be prevented from falling out of the second arms 114, 114 when the second arms 114, 114 are expanded by the person slumping over the arms.

To the grasping member 104, one end of the cylinder 120 and one end of the engagement pin cylinder 500 are pivotally connected, sandwiching the grasping member 104. The other end portion of the cylinder 120 is connected to a conversion member 506 for changing an extending/contracting motion of the cylinder 120 into a pivoting motion of the first pins 502.

The conversion member 506 is configured of a pivot member 506A pivotally connected to the other end of the cylinder 120, and a lever 506B connecting the pivot member 506A with the first pins 502. As the cylinder 120 is extended, the lever 506B pivots about the first pins 502 as the fulcrum. The pivoting also causes the first pins 502 to pivot. As the first pins 502 pivot, the first arms 112 pivot about the first pins 502 as the fulcrum. Accordingly, as in the first embodiment, the extension or contraction of the cylinder 120 causes the first arms 112 to pivot about their connection portions with the protrusion members 108 (i.e., the first pins 502) as the fulcrum.

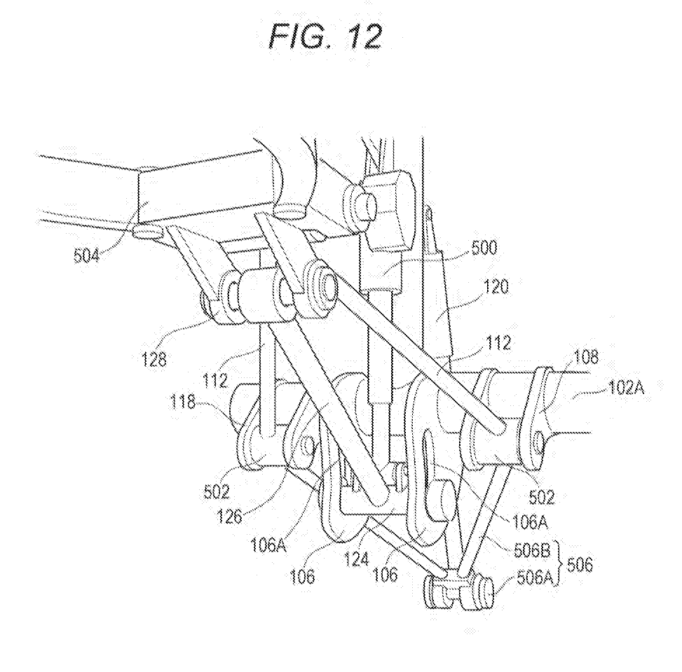

Reference is further made to FIG. 12 as well as FIGS. 10 and 11. FIG. 12 is an enlarged perspective view of the vicinity of the engagement pin 124 of the transfer device according to the second embodiment of the present invention. The engagement pin 124 is pivotally connected to the other end of the engagement pin cylinder 500. In this way, by extending or contracting the engagement pin cylinder 500, the position of the engagement pin 124 in the elongated holes 106A can be freely modified and fixed.

One end of the third arm 126 is connected to the engagement pin 124, which is adapted to pivot in the elongated holes 106A. The other end of the third arm is pivotally connected to the arm connecting member 128 fixed to the support member 504. The lower side 102B is provided with the two leg portions 110, 110 horizontally pivotally connected to the lower side 102B at their connection portions. It goes without saying that the leg portions 110, 110 may have variations similar to those according to the first embodiment. The transfer device 101 may also have variations in its various portions similar to the variations of the transfer device 100 according to the first embodiment.

### (2) Second Arm Angle During Operation

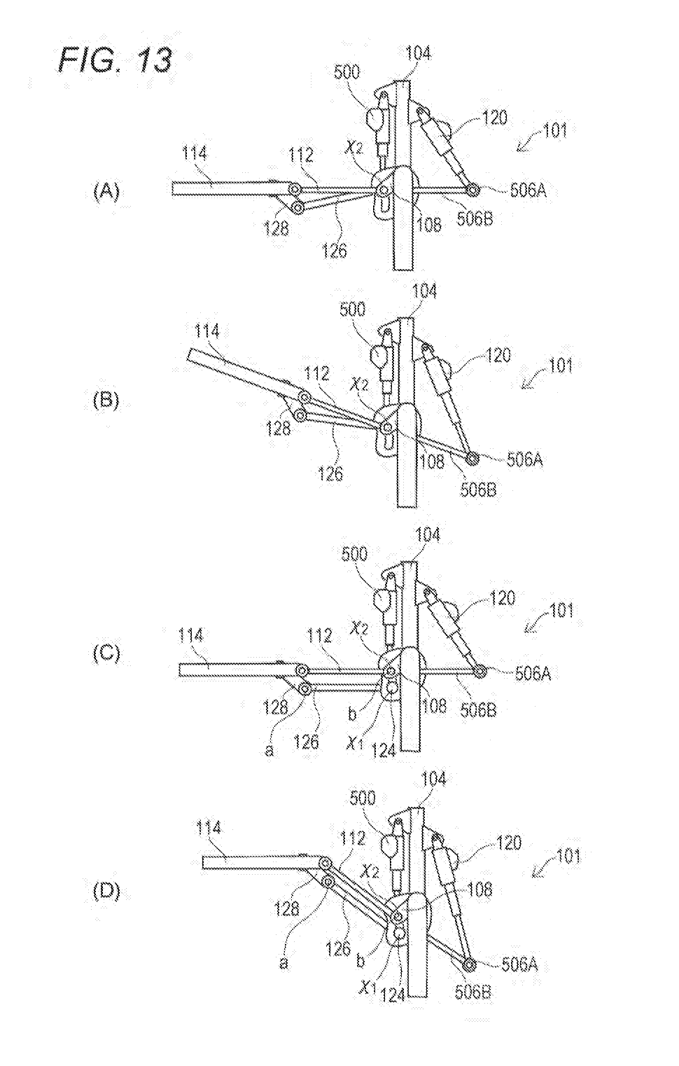

The angle of the second arms 114 when the cylinder 120 is extended or contracted will be described with reference to FIGS. 10 to 13. FIG. 13 is a projection view toward the side of the transfer device illustrating the angle of the second arms 114. The angle of the second arms 114, which is similar to that according to the first embodiment, will be described in the following.

As illustrated in FIG. 13(A), the engagement pin 124 (which is hidden behind the first pins 502) is, in the projection view toward the side, at the same position as the connection portion between the first arms 112 and the protrusion members 108. In this case, as the cylinder 120 is extended, the third arm 126 is rotated about the position x₂ as the fulcrum. Namely, in the side view, the third arm 126 is rotated about the same position as the connection portion between the first arms 112 and the protrusion members 108 as the fulcrum in the same way as the first arms 112. Accordingly, the second arms 114 supported on the third arm 126 is rotated while maintaining their linearly aligned state with the first arms 112, as illustrated in FIG. 13(B).

As a result of a number of researches, the present inventor has realized that the second arms 114 can be lifted while maintaining the horizontal state by extending the cylinder 120 as illustrated in FIGS. 13(C) and 13(D), when, in the projection view toward the side, the engagement pin 124 is positioned at position x₁ where A=B, where A is the distance between the position of the engagement pin 124 x₁ in the elongated holes 106A and the connected position a of the third arm 126 and the arm connecting member 128 (x₁−a distance), and B is the distance between the connected position b of the first arms 112 and the protrusion members 108 and a (b−a distance).

In the transfer device 101 according to the present invention, the position x₁ where A=B is present in the elongated holes 106A. At this position, the engagement pin 124 can be positioned. Accordingly, the second arms 114 can be lifted and lowered while maintaining the horizontal state thereof. In this way, the body of the person in need of nursing care can be lifted and lowered continuously horizontally with the second arms 114 hold in the armpits, without tilting the body of the person. Accordingly, the person can be stably transferred without causing a sense of fear in the person.

The operations of the transfer device 101 according to the second embodiment of the present invention with respect to a wheelchair, bed, or the like are identical to the operations and effects described with reference to the first embodiment. Accordingly, description of the operations and effects will be omitted.

### LIST OF NUMERAL REFERENCES

100 . . . transfer device, 101 . . . transfer device, 102 . . . frame, 102A . . . upper side, 102B . . . lower side, 104 . . . grasping member, 106 . . . elongated-hole member, 106A . . . elongated hole, 108 . . . protrusion member, 110 . . . leg portion, 112 . . . first arm, 114 . . . second arm, 116 . . . first bar member, 118 . . . second bar member, 120 . . . cylinder, 122 . . . connecting member, 124 . . . engagement pin, 126 . . . third arm, 128 . . . arm connecting member, 130 . . . wheel, 132 . . . belt, 200 . . . wheelchair, 300 . . . person in need of nursing care, 302 . . . seat face, 310 . . . bed, 400 . . . base, 500 . . . engagement pin cylinder, 502 . . . first pin, 504 . . . support member, 504A . . . pin, 506 . . . conversion member, 506A . . . pivot member, 506B . . . lever

1. A transfer device for transferring a person in need of nursing care, comprising:
a U-shaped frame including an upper side and a lower side opposed to each other, the U-shaped frame being configured to be inserted into a bed in such a manner as to sandwich the bed between the upper side and the lower side;
a transfer unit mounted to the upper side to lift the person in need of nursing care; and
a leg portion mounted to the lower side, wherein
the transfer unit includes an arm extending in a perpendicular direction from a U-shaped plane of the frame, the arm being configured to be inserted in an armpit of the person in need of nursing care to hold up the person in need of nursing care from under the armpit.

2. The transfer device according to claim 1, wherein
the arm includes a first arm and a second arm, and
the transfer unit includes:
a pair of protrusion members fixed to the upper side;
a pair of the first arms having one end portions thereof pivotally connected to an end portion of the pair of protrusion members;
a pair of the second arms each pivotally connected to another end portion of each of the pair of first arms;
a first bar member connecting the end portions on the second arm side of the pair of first arms;
a second bar member connecting the pair of second arms;
a cylinder having one end portion thereof pivotally grasped by a grasping member fixed to the upper side;
a connecting member connecting another end portion of the cylinder and the first bar member so as to enable the cylinder to pivot;
an elongated-hole member fixed to the upper side and having an elongated hole;
a third arm having one end portion thereof fixed to an engagement pin engaged in the elongated hole; and
an arm connecting member fixed to the second bar member and connected to another end portion of the third arm so as to enable the third arm to pivot.

3. The transfer device according to claim 2, wherein the transfer device is configured to be switchable, by changing the position of the engagement pin in the elongated hole, between a mode in which the second arm is moved up and down while maintaining a horizontal state, and a mode in which the second arm is moved up and down while being inclined so as to be lower toward the frame when the cylinder is extended or contracted.

4. The transfer device according to claim 2, wherein, in a lateral projection view, by extending or contracting the cylinder, the second arm is lifted or lowered while maintaining a horizontal state when the cylinder is extended or contracted when the engagement pin is disposed in the elongated hole at a position where A=B, where A is a distance between a position in the elongated hole and a connection portion of the arm connecting member and the third arm, and B is a distance between a connection portion of the protrusion member and the first arm and the connection portion of the arm connecting member and the third arm.

5. The transfer device according to claim 1, wherein
the arm includes a first arm and a second arm, and
the transfer unit includes:
a protrusion member fixed to the upper side;
the first arm having one end pivotally connected to an end portion of the protrusion member via a first pin;
a support member connected to another end portion of the first arm so as to enable the first arm to pivot;
a pair of the second arms connected to the support member;
a cylinder and an engagement pin cylinder each having one end pivotally connected to a grasping member fixed to the upper side;
a conversion member connecting the other end portion of the cylinder and the first pin to convert an extending/contracting motion of the cylinder into a pivoting motion of the first pin;
an elongated-hole member fixed to the upper side and having an elongated hole;
an engagement pin engaged in the elongated hole and fixed to the other end of the engagement pin cylinder so as to be movable in the elongated hole by an extending/contracting motion of the engagement pin cylinder;
a third arm having one end fixed to the engagement pin; and
an arm connecting member fixed to the support member and connected to the other end of the third arm so as to enable the third arm to pivot, and
the leg portion is connected to the lower side so as to extend in the same direction as the second arm with respect to a U-shaped plane of the frame, the leg portion having a wheel fitted thereto.

6. The transfer device according to claim 5, wherein the transfer device is configured to be switchable, by changing the position of the engagement pin in the elongated hole, between a mode in which the second arm is moved up and down while maintaining a horizontal state, and a mode in which the second arm is moved up and down while being inclined so as to be lower toward the frame when the cylinder is extended or contracted.

7. The transfer device according to claim 5, wherein, in a lateral projection view, by extending or contracting the cylinder, the second arm is moved up and down while maintaining a horizontal state when the cylinder is extended or contracted when the engagement pin is disposed in the elongated hole at a position where A=B, where A is a distance between a position in the elongated hole and a connection portion of the arm connecting member and the third arm, and B is a distance between a connection portion of the protrusion member and the first arm and the connection portion of the arm connecting member and the third arm.

8-12. (canceled)

13. The transfer device according to claim 1, wherein the arm is configured to rotate about a center of rotation at an end portion thereof facing the upper side to diagonally hold up the person in need of nursing care from under the armpit.

14. The transfer device according to claim 1, wherein the arm, when rotated about the center of rotation at the end portion facing the upper side, holds up the person in need of nursing care by rising while maintaining a horizontal state in the armpit of the person in need of nursing care.

15. The transfer device according to claim 1, wherein the transfer unit is configured to be switched between a mode in which the person in need of nursing care is diagonally held up from under the armpit by the arm rotating about the center of rotation at the end portion facing the upper side, and a mode in which the person in need of nursing care is held up by the arm rising while maintaining a horizontal state in the armpit of the person in need of nursing care.

16. The transfer device according to claim 13, wherein the transfer unit is configured to be switched between a mode in which the person in need of nursing care is diagonally held up from under the armpit by the arm rotating about the center of rotation at the end portion facing the upper side, and a mode in which the person in need of nursing care is held up by the arm rising while maintaining a horizontal state in the armpit of the person in need of nursing care.

17. The transfer device according to claim 14, wherein the transfer unit is configured to be switched between a mode in which the person in need of nursing care is diagonally held up from under the armpit by the arm rotating about the center of rotation at the end portion facing the upper side, and a mode in which the person in need of nursing care is held up by the arm rising while maintaining a horizontal state in the armpit of the person in need of nursing care.

18. The transfer device according to claim 13, wherein
the arm includes a first arm and a second arm, and
the transfer unit includes:
a pair of protrusion members fixed to the upper side;
a pair of the first arms having one end portions thereof pivotally connected to an end portion of the pair of protrusion members;
a pair of the second arms each pivotally connected to another end portion of each of the pair of first arms;
a first bar member connecting the end portions on the second arm side of the pair of first arms;
a second bar member connecting the pair of second arms;
a cylinder having one end portion thereof pivotally grasped by a grasping member fixed to the upper side;
a connecting member connecting another end portion of the cylinder and the first bar member so as to enable the cylinder to pivot;
an elongated-hole member fixed to the upper side and having an elongated hole;
a third arm having one end portion thereof fixed to an engagement pin engaged in the elongated hole; and
an arm connecting member fixed to the second bar member and connected to another end portion of the third arm so as to enable the third arm to pivot.

19. The transfer device according to claim 14, wherein
the arm includes a first arm and a second arm, and
the transfer unit includes:
a pair of protrusion members fixed to the upper side;
a pair of the first arms having one end portions thereof pivotally connected to an end portion of the pair of protrusion members;
a pair of the second arms each pivotally connected to another end portion of each of the pair of first arms;
a first bar member connecting the end portions on the second arm side of the pair of first arms;
a second bar member connecting the pair of second arms;
a cylinder having one end portion thereof pivotally grasped by a grasping member fixed to the upper side;
a connecting member connecting another end portion of the cylinder and the first bar member so as to enable the cylinder to pivot;
an elongated-hole member fixed to the upper side and having an elongated hole;
a third arm having one end portion thereof fixed to an engagement pin engaged in the elongated hole; and
an arm connecting member fixed to the second bar member and connected to another end portion of the third arm so as to enable the third arm to pivot.

20. The transfer device according to claim 1, wherein the leg portion is connected to the lower side so as to extend on an arm side from the U-shaped plane of the frame.

21. The transfer device according to claim 18, wherein the leg portion is connected to the lower side so as to extend on an arm side from the U-shaped plane of the frame.

22. The transfer device according to claim 19, wherein the leg portion is connected to the lower side so as to extend on an arm side from the U-shaped plane of the frame.

23. The transfer device according to claim 18, wherein the transfer device is configured to be switchable, by changing the position of the engagement pin in the elongated hole, between a mode in which the second arm is moved up and down while maintaining a horizontal state, and a mode in which the second arm is moved up and down while being inclined so as to be lower toward the frame when the cylinder is extended or contracted.

24. The transfer device according to claim 18, wherein, in a lateral projection view, by extending or contracting the cylinder, the second arm is lifted or lowered while maintaining a horizontal state when the cylinder is extended or contracted when the engagement pin is disposed in the elongated hole at a position where A=B, where A is a distance between a position in the elongated hole and a connection portion of the arm connecting member and the third arm, and B is a distance between a connection portion of the protrusion member and the first arm and the connection portion of the arm connecting member and the third arm.

25. The transfer device according to claim 19, wherein, in a lateral projection view, by extending or contracting the cylinder, the second arm is lifted or lowered while maintaining a horizontal state when the cylinder is extended or contracted when the engagement pin is disposed in the elongated hole at a position where A=B, where A is a distance between a position in the elongated hole and a connection portion of the arm connecting member and the third arm, and B is a distance between a connection portion of the protrusion member and the first arm and the connection portion of the arm connecting member and the third arm.
